(19) United States
(12) Patent Application Publication
(10) Pub. No.: US 2019/0204613 A1
(43) Pub. Date: Jul. 4, 2019

(54) REFLECTIVE LIGHT MODULATION DEVICE, PROJECTOR AND AR/VR DISPLAY

(71) Applicants: BOE Technology Group Co., Ltd., Beijing (CN); BEIJING BOE DISPLAY TECHNOLOGY CO., LTD., Beijing (CN)

(72) Inventors: Zhidong Wang, Beijing (CN); Yun Qiu, Beijing (CN); Lianjie Qu, Beijing (CN); Zhenhua Lv, Beijing (CN)

(21) Appl. No.: 16/015,531

(22) Filed: Jun. 22, 2018

(30) Foreign Application Priority Data
Jan. 3, 2018 (CN) 201810006239.8

(51) Int. Cl. G02B 27/28; G02F 1/1343; G02F 1/1335; G02F 1/133; G03B 21/00

(52) U.S. Cl. CPC G02B 27/283; G02F 1/13439; G02F 2203/02; G02F 1/13306; G03B 21/006; G02F 1/133553

(57) ABSTRACT

A reflective light modulation device, a projector and an AR/VR display are provided. The reflective light modulation device includes a light source, a polarization beam splitting layer which transmits and reflects light of the light source to form two beams of linearly polarized light perpendicular to each other, a first modulation reflective layer disposed in a propagation direction of a beam of linearly polarized light transmitted by the polarization beam splitting layer, and a second modulation reflective layer disposed in a propagation direction of another beam of the linearly polarized light reflected by the polarization beam splitting layer, wherein the first modulation reflective layer and the second modulation reflective layer perform a modulation synchronously.

### CROSS-REFERENCE TO RELATED APPLICATION

This application claims the benefit of Chinese Patent Application No. 201810006239.8 filed on Jan. 3, 2018 in the State Intellectual Property Office of China, the whole disclosure of which is incorporated herein by reference.

### BACKGROUND OF THE INVENTION

### Field of the Invention

This disclosure relates generally to the field of display technology, and particularly to a reflective light modulation device, a projector and an AR/VR display.

### Description of the Related Art

A structure of a reflective light modulation device employed in AR/VR displays generally divides light emitted from a light source into two beams of linearly polarized light that are perpendicular to each other through a polarization beam splitter, only one of the two beams of the polarization light is modulated by a silicon-based liquid crystal layer and then enters the projection lens. Thus, the reflective light modulation device doesn't fully use the polarized light.

### SUMMARY OF THE INVENTION

According to an aspect of the present disclosure, there is provided a reflective light modulation device, comprising:

a light source,

a polarization beam splitting layer which transmits and reflects light of the light source to form two beams of linearly polarized light perpendicular to each other,

a first modulation reflective layer disposed in a propagation direction of a beam of linearly polarized light transmitted by the polarization beam splitting layer, and

a second modulation reflective layer disposed in a propagation direction of another beam of the linearly polarized light reflected by the polarization beam splitting layer,

wherein the first modulation reflective layer and the second modulation reflective layer perform a modulation synchronously.

In an embodiment, the polarization beam splitting layer is disposed in a propagation direction of the light of the light source.

In an embodiment, a projection lens is disposed on a side of the polarization beam splitting layer facing away from the second modulation reflective layer.

In an embodiment, the polarization beam splitting layer is arranged at an angle with the second modulation reflective layer.

In an embodiment, the angle is 45 degrees.

In an embodiment, the polarization beam splitting layer is specifically a polarization beam splitter.

In an embodiment, the polarizing beam splitter is formed by bonding a plurality of right angle prisms, and one of the right angle prisms is coated with a polarizing beam splitter media film on an oblique side thereof.

In an embodiment, the oblique side of the one of the right angle prisms is arranged at an angle of 45 degrees with the second modulation reflective layer.

In an embodiment, a collimating lens is disposed between the light source and the polarization beam splitting layer.

In an embodiment, the first modulation reflective layer and the second modulation reflective layer are silicon-based liquid crystals.

In an embodiment, the silicon-based liquid crystal is sequentially provided with a glass layer, a light-transmissive electrode layer, a liquid crystal layer, a metal reflective electrode layer and a drive circuit layer in a light entering direction.

In an embodiment, the light-transmissive electrode layer is an ITO electrode layer.

In an embodiment, the metal reflective electrode layer is an aluminized electrode layer.

In an embodiment, the drive circuit layer comprises a CMOS active drive circuit.

According to an aspect of the present disclosure, there is provided a projector, comprising the reflective light modulation device mentioned above.

According to an aspect of the present disclosure, there is provided an AR/VR display, comprising the reflective light modulation device mentioned above.

### BRIEF DESCRIPTION OF THE DRAWINGS

FIG. 1 illustrates an exemplary schematic view of a reflective light modulation device operating in a bright state according to the present disclosure, and

FIG. 2 illustrates an exemplary schematic diagram of a reflective light modulation device operating in a dark state according to the present disclosure.

### DETAILED DESCRIPTION OF PREFERRED EMBODIMENTS

The present disclosure will be further described below with reference to the accompanying drawings and embodiments. It is to be understood that the specific embodiments described herein are for the purpose of explanation only and not for the limitation to this disclosure. Further, it is to be noted that for convenience of description, only portions relative to the disclosure are shown in the drawings.

It should be noted that the embodiments in the present disclosure and the features in the embodiments may be combined with each other without conflict. The present disclosure will be described in detail below with reference to the drawings and in combination with the embodiments.

According to the general inventive concept of the present disclosure, there is provided a reflective light modulation device, comprising: a light source, a polarization beam splitting layer which transmits and reflects light of the light source to form two beams of linearly polarized light perpendicular to each other, a first modulation reflective layer disposed in a propagation direction of a beam of linearly polarized light transmitted by the polarization beam splitting layer, and a second modulation reflective layer disposed in a propagation direction of another beam of the linearly polarized light reflected by the polarization beam splitting layer, wherein the first modulation reflective layer and the second modulation reflective layer perform a modulation synchronously.

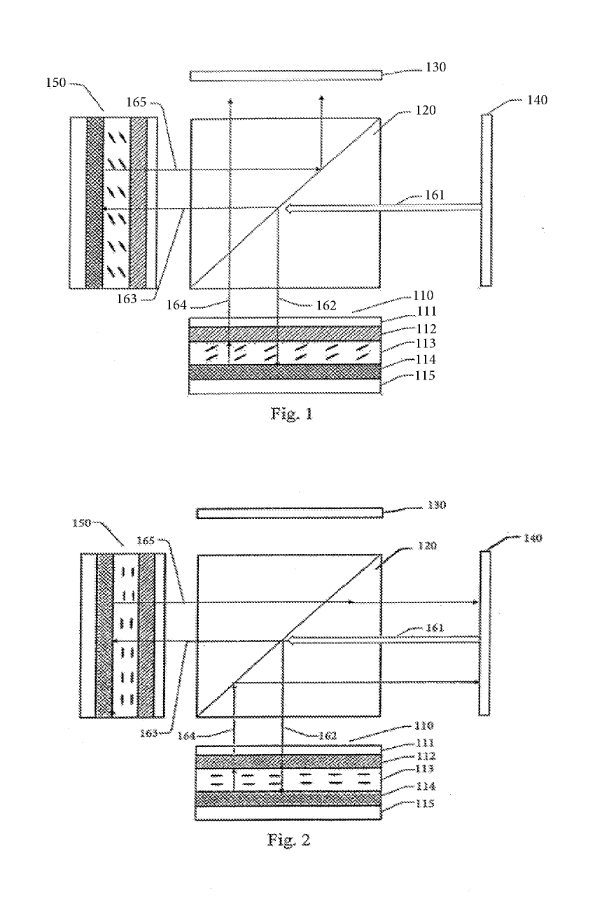

Referring to FIG. 1, it illustrates an exemplary schematic diagram of a reflective light modulation device operating in a bright state according to the present disclosure. As shown in FIG. 1, the reflective light modulation device includes:

a light source 140,

a polarization beam splitting layer is arranged along a light propagation direction of the light source, the polarization beam splitting layer divides light of the light source into two beams of linearly polarized light whose propagation directions are perpendicular to each other,

a first modulation reflective layer 150 is disposed in a propagation direction of a beam of linearly polarized light transmitted by the polarization beam splitting layer, and a second modulation reflective layer 110 is disposed in a propagation direction of a beam of linearly polarized light reflected by the polarization beam splitting layer. The first modulation reflective layer 150 and the second modulation reflective layer 110 perform a modulation synchronously. A projection lens 130 is disposed on a side of the polarization beam splitting layer facing away from the second modulation reflective layer 110.

In FIGS. 1 and 2, the polarization beam splitting layer is specifically a polarized beam splitter 120. The polarization beam splitter 120 is capable of splitting light of the light source into a beam of S linearly polarized light 162 and a beam of P linearly polarized light 163 the propagation directions of which are perpendicular to each other. As shown in FIG. 1, the light 161 emitted from the light source is divided into S polarized light 162 and P polarized light 163 through the polarization beam splitting layer 120. The light 161 emitted from light source 140 is split into P polarized light 163 and S polarized light 162 through the polarization beam splitting layer 120, which enter the first modulation reflective layer 150 and the second modulation reflective layer 110 respectively, and the light which is reflected by the first modulation reflective layer 150 and the second modulation reflective layer 110 again passes through the polarization beam splitting layer 120, and then enters projection lens 130 or exits outside according to characteristics of the light.

The first modulation reflective layer 150 and the second modulation reflective layer 110 perform the modulations synchronously. That is, the first modulation reflective layer 150 is operating in a modulation mode while the second modulation reflective layer 110 is also operating in the modulation mode. The first modulation reflective layer 150 is operating in a non-modulation mode while the second modulation reflective layer 110 is also operating in the non-modulation mode.

In some embodiments, the polarization beam splitting layer 120 is particularly a polarizing beam splitter, which may be formed by bonding high precision direct angle prisms. One of the prisms is coated with a polarization beam splitting media film on its oblique side, such an oblique side is arranged at an angle with the second modulation reflective layer 110. In one embodiment, the angle is 45 degrees.

In one embodiment, a collimating lens may be disposed between the light source and the polarization beam splitting layer 120. The collimating lens is used to collimate the light 161 emitted from the light source.

In one embodiment, the first modulation reflective layer and the second modulation reflective layer are specifically silicon-based liquid crystals. The incident light is modulated by controlling deflection of the liquid crystal.

In some embodiments, the silicon-based liquid crystal is sequentially provided with a glass layer 111, a light-transmissive electrode layer 112, a liquid crystal layer 113, a metal reflective electrode layer 114, and a drive circuit layer 115 in the light-entering direction. The first modulation reflective layer 150 and the second modulation reflective layer 110 may employ the same silicon-based liquid crystal structure.

In one embodiment, the light-transmissive electrode layer 112 is Indium Tin Oxide, (referred to as ITO) electrode layers. ITO is an n-type semiconductor material having a high conductivity, a high transmittance to visible light, a high mechanical hardness and a good chemical stability.

In one embodiment, the metal reflective electrode layer 114 is an aluminized electrode layer. A polished aluminum layer may be employed for providing electrodes and light reflections.

In one embodiment, the drive circuit layer 115 includes a CMOS active drive circuit. The drive circuit layer 115 may be fabricated using a Complementary Metal-Oxide Semiconductor (referred to as CMOS) process for controlling deflection of the liquid crystal layer 113.

As shown in FIG. 1, when the modulation reflective layer is operated in a modulation mode, the light 161 emitted from the light source is divided into S polarized light 162 and P polarized light 163 through the polarizing beam splitter 120, and the S polarized light 162 enters the modulation reflective layer 110. The modulation reflective layer 110 modulates light, the S polarized light is converted into P polarized light 164, the P polarized light 164 may pass through the polarizing beam splitter 120 and enter the projection lens 130. In addition, P polarized light 163 enters modulation reflective layer 150, the modulation reflective layer 150 modulates the light and converts the P polarized light 163 into S polarized light 165, which is reflected at a 45-degree angle and then enter the projection lens 130. At this point, a bright state is displayed. Almost all of the light is used for display, and the light utilization rate is improved. The display brightness is greatly improved.

Next, referring to FIG. 2, it illustrates an exemplary schematic diagram of a reflective light modulation device operating in a dark state according to the present disclosure. As shown in FIG. 2, the modulation reflective layer is in the non-modulation mode, the light 161 emitted from the light source is divided into S polarized light 162 and P polarized light 163 through the polarizing beam splitter 120, the S polarized light 162 enters the modulation reflective layer 110, the modulation reflective layer 110 doesn't modulate the light, the S polarization light 164 reflected by the reflective electrode layer 114 exits outside after being reflected at a 45-degree angle. In addition, the P polarized light 163 enters the modulation reflective layer 150, which does not modulate light, the reflected P polarized light 165 is emitted to the outside by the polarizing beam splitter 120. At this point, the dark state is displayed.

The foregoing description is merely one embodiment of the present disclosure and is illustrative of the principles employed in the present application. Those skilled in the art will appreciate that the disclosed scope is not limited to the technical solution of the particular combination of features described above, and also should be construed as including other technical solutions formed by any combination of the above technical features or their equivalent features without departing from the inventive concept. For example, the above-described features and technical features disclosed in the present disclosure (but not limited thereto) having similar functions may be mutually replaced to obtain the solutions which should be included in the scope of the present application.

What is claimed is:

1. A reflective light modulation device, comprising:
a light source,
a polarization beam splitting layer which transmits and reflects light of the light source to form two beams of linearly polarized light perpendicular to each other,
a first modulation reflective layer disposed in a propagation direction of a beam of linearly polarized light transmitted by the polarization beam splitting layer, and
a second modulation reflective layer disposed in a propagation direction of another beam of the linearly polarized light reflected by the polarization beam splitting layer,
wherein the first modulation reflective layer and the second modulation reflective layer perform a modulation synchronously.

2. The reflective light modulation device according to claim 1, wherein the polarization beam splitting layer is disposed in a propagation direction of the light of the light source.

3. The reflective light modulation device according to claim 1, wherein a projection lens is disposed on a side of the polarization beam splitting layer facing away from the second modulation reflective layer.

4. The reflective light modulation device according to claim 1, wherein the polarization beam splitting layer is arranged at an angle with the second modulation reflective layer.

5. The reflective light modulation device according to claim 4, wherein the angle is 45 degrees.

6. The reflective light modulation device according to claim 1, wherein the polarization beam splitting layer is specifically a polarization beam splitter.

7. The reflective light modulation device according to claim 6, wherein the polarizing beam splitter is formed by bonding a plurality of right angle prisms, and one of the right angle prisms is coated with a polarizing beam splitter media film on an oblique side thereof.

8. The reflective light modulation device according to claim 7, wherein the oblique side of the one of the right angle prisms is arranged at an angle of 45 degrees with the second modulation reflective layer.

9. The reflective light modulation device according to claim 1, wherein a collimating lens is disposed between the light source and the polarization beam splitting layer.

10. The reflective light modulation device according to claim 1, wherein the first modulation reflective layer and the second modulation reflective layer are silicon-based liquid crystals.

11. The reflective light modulation device according to claim 10, wherein the silicon-based liquid crystal is sequentially provided with a glass layer, a light-transmissive electrode layer, a liquid crystal layer, a metal reflective electrode layer and a drive circuit layer in a light entering direction.

12. The reflective light modulation device according to claim 11, wherein the light-transmissive electrode layer is an ITO electrode layer.

13. The reflective light modulation device according to claim 12, wherein the metal reflective electrode layer is an aluminized electrode layer.

14. The reflective light modulation device according to claim 13, wherein the drive circuit layer comprises a CMOS active drive circuit.

15. A projector, comprising the reflective light modulation device according to claim 1.

16. An AR/VR display, comprising the reflective light modulation device according to claim 1.
